(19) United States
(12) Patent Application Publication
(10) Pub. No.: US 2023/0001969 A1
(43) Pub. Date: Jan. 5, 2023

(54) OPERATION DETERMINATION DEVICE, OPERATION DETERMINATION METHOD, AND STORAGE MEDIUM

(71) Applicant: NEC Corporation, Minato-ku, Tokyo (JP)

(72) Inventors: Shumpei KUBOSAWA, Tokyo (JP); Takashi ONISH, Tokyo (JP)

(73) Assignee: NEC Corporation, Minato-ku, Tokyo (JP)

(21) Appl. No.: 17/778,602

(22) PCT Filed: Nov. 25, 2019
(86) PCT No.: PCT/JP2019/045999

§ 371 Date: May 20, 2022

(51) Int. Cl. B61L 27/60

(52) U.S. Cl. CPC B61L 27/60

(57) ABSTRACT

An operation determination device adapted to a system including a carriage machinery for carrying carriage targets and facilities relating to an operation of the carriage machinery includes a determination means configured to produce an operation plan of the carriage machinery to improve a quantitative evaluation status of the carriage targets using a simulator configured to simulate the operation of the carriage machinery.

### TECHNICAL FIELD

The present invention relates to an operation determination device, an operation determination method, and a storage medium.

### BACKGROUND ART

With regard to an operation of a transportation system, Patent Document 1 discloses a diagram generation device configured to generate diagrams for operating special shuttle buses using multiple types of buses having different capacities of passengers and different vehicle performances.

### CITATION LIST

### Patent Literature Document

Patent Document 1: Japanese Patent No. 6251083

### SUMMARY OF INVENTION

### Technical Problem

To operate transportation systems, it is preferable to carry out traffic services by paying careful attention to users' conveniences in addition to convenience of traffic operators.

An exemplary object of the present invention is to provide an operation determination device, an operation determination method, and a storage medium which can solve the aforementioned problem.

### Solution to Problem

In a first aspect of the present invention, an operation determination device adapted to a system including a carriage machinery for carrying carriage targets and facilities relating to an operation of the carriage machinery includes a determination means configured to produce an operation plan of the carriage machinery to improve a quantitative evaluation status of the carriage targets using a simulator configured to simulate the operation of the carriage machinery.

In a second aspect of the present invention, an operation determination method adapted to a system including a carriage machinery for carrying carriage targets and facilities relating to an operation of the carriage machinery includes a step of producing an operation plan of the carriage machinery to improve a quantitative evaluation status of the carriage targets using a simulator configured to simulate the operation of the carriage machinery.

In a third aspect of the present invention, a storage medium is configured to store a program causing a computer adapted to a system including a carriage machinery for carrying carriage targets and facilities relating to an operation of the carriage machinery to implement a step of producing an operation plan of the carriage machinery to improve a quantitative evaluation status of the carriage targets using a simulator configured to simulate the operation of the carriage machinery.

### Advantageous Effects of Invention

According to the operation determination device, the operation determination method, and the storage medium described above, it is possible to produce an operation plan by paying attention to users' convenience.

### BRIEF DESCRIPTION OF DRAWINGS

FIG. 1 is a block diagram showing a functional configuration example of an operation determination device according to the exemplary embodiment.

FIG. 2 is a schematic diagram showing an example of data flows in a simulator according to the exemplary embodiment.

FIG. 3 is a schematic diagram showing an example of routes in a transportation system for which the operation determination device of the exemplary embodiment intends to produce an operation plan for carriage machinery.

FIG. 4 is a schematic diagram showing a configuration example of facilities installed in a station serving as a simulation model of a simulator according to the exemplary embodiment.

FIG. 5 is a flowchart showing an exemplary procedure performed by a module for straight movement of railway vehicles according to the exemplary embodiment.

FIG. 6 is a flowchart showing an exemplary procedure performed by a module for loopback movement of railway vehicles according to the exemplary embodiment.

FIG. 7 is a flowchart showing an exemplary procedure performed by the operation determination device according to the exemplary embodiment.

FIG. 8 is a block diagram showing a configuration example of the operation determination device according to the exemplary embodiment.

FIG. 9 is a flowchart showing an exemplary procedure of an operation determination method according to the exemplary embodiment.

FIG. 10 is a block diagram showing a configuration of a computer according to at least one exemplary embodiment.

### EXAMPLE EMBODIMENTS

Hereinafter, the present invention will be described by way of non-limiting exemplary embodiments; however, the following embodiments do not necessarily limit the scope of the invention as defined in the appended claims. In addition, all the combinations of features described in the following embodiments need not be essential to the solving means of the invention.

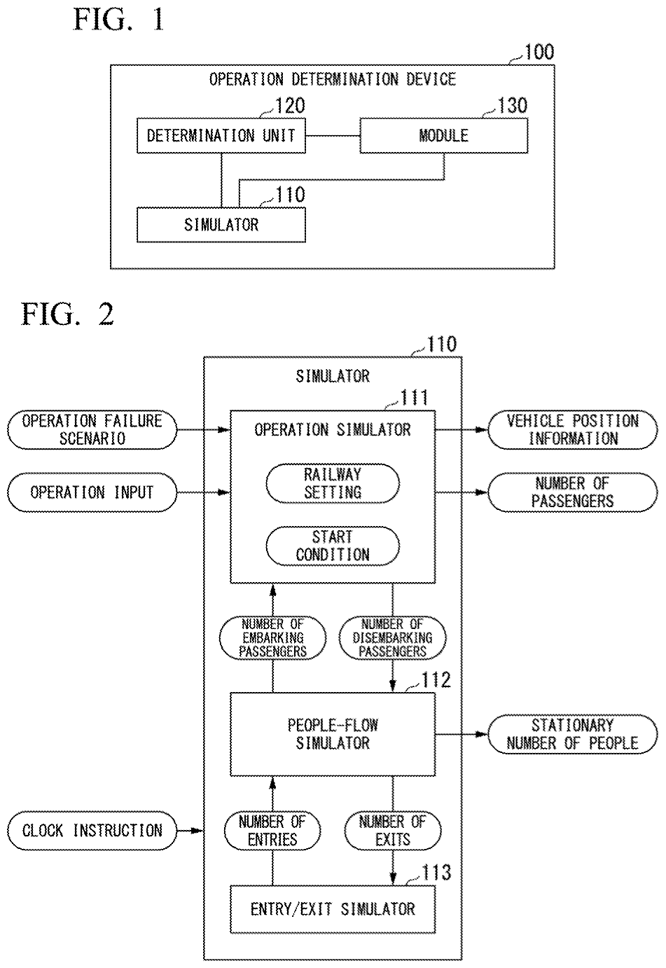

FIG. 1 is a block diagram showing a functional configuration example of an operation determination device according to the exemplary embodiment. According to the configuration shown in FIG. 1, an operation determination device 100 includes a simulator 110, a determination unit 120, and a module 130.

The operation determination device 100 is configured to produce an operation plan for carriage machinery. For example, the operation determination device 100 may output the information representing a diagram such as an example of an operation pattern of carriage machinery. In particular, the operation determination device 100 is configured to acquire and output an operation plan of carriage machinery in order to improve a quantitative evaluation status of carriage targets to be carried by carriage machinery.

A transportation system may include carriage machinery and its platform. Herein, the transportation system is a generic term collectively integrating carrier devices and facilities for operating carrier devices. Herein, the operation of carriage machinery may cause carriage machinery to operate according to some plans.

The following description refers to an exemplary case of acquiring an operation plan of carriage machinery in order to improve a stationary status of carriage targets to be carried by carriage machinery at its platform. In this connection, a subject to be improved by an operation plan produced by the operation determination device 100 is not necessarily limited to a stationary status of carriage targets at a platform. For example, the operation determination device 100 may acquire an operation plan of carriage machinery to improve the speed of the carrier device. Herein, an improvement in speed of carriage machinery can be achieved by reducing time needed to carry objects by increasing speed of carriage machinery.

The following description exemplarily refers to a vehicle as carriage machinery subjected to the operation determination device 100 and people as carriage targets. In particular, the following description exemplarily refers to railway vehicles as carriage machinery subjected to the operation determination device 100. In this case, a transportation system will be referred to as a railway system. Herein, the railway system is a generic term collectively integrating railway vehicles and facilities for operating railway vehicles. In this connection, a railway vehicle can be operated as a train interconnecting two or more vehicles together or a single vehicle which may operate alone.

When people are carried by carriage machinery, persons as carriage targets would be users of carriage machinery. Hereinafter, users of carriage machinery will be simply referred to as users.

In this connection, carriage machinery subjected to the operation determination device 100 may carry objects such as articles rather than persons. In this case, a client who requests carrying objects serving as carriage targets may correspond to a user. Carriage machinery may represent carriers, belt conveyors, or pipelines configured to carry products and materials in production plants, warehouses, or the like. A platform may represent a storage place such as a tank which can store products and materials. Accordingly, a stationary status may represent an amount of products and materials stored in each storage place or a ratio of an amount of products and materials to a capacity of each storage place.

In the case of a production plant, for example, a stationary status may represent an amount of works in process before being processed in a certain manufacturing process or an amount of works in process which has been completed in one manufacturing process but which has not been carried to the next manufacturing process.

When the operation determination device 100 is intended for carriage targets such as persons to be carried by carriage machinery, the carrier device is not necessarily limited to a railway vehicle. For example, the carrier device may be an aircraft, a seacraft, a taxi, a truck, a bus or other transportation vehicles.

In the above, a stationary status of carriage targets may indicate a status of carriage targets which stay at the same place without moving to other places. In the case of a railway system as a transportation system, a stationary status of carriage targets may refer to a condition in which a user stays at a railway station or a platform or in which a user waits for a railway vehicle at a platform.

A shorter stationary time would be preferable for passengers who aim to travel via carriage machinery. In this connection, it is possible for the operation determination device 100 to produce an operation plan considering users' convenience via carriage machinery when improving a stationary status.

In the case of a carriage target as an object, it is preferable for a user that the object be transported speedily. In the case of a production plant or a warehouse, a reduction may occur in a production status or a shipping status due to carriage targets being piled up for a long time in a production plant or a warehouse. In this case, it is possible for the operation determination device 100 to produce an operation plan considering users' convenience via carriage machinery when improving a stationary status. Therefore, it is preferable to reduce a stationary time.

The operation determination device 100 may control an operation of carriage machinery based on the operation plan produced thereby. Alternatively, the operation determination device 100 may output an operation plan to an external device such as a control device of a transportation system such that the external device can control an operation of carriage machinery based on the operation plan. For example, the operation determination device 100 may instruct or control carriage machinery to operate according to an operation plan produced thereby. Alternatively, the operation determination device 100 may control signals of a transportation system such that carriage machinery be controlled according to an operation plan produced thereby.

Alternatively, a manager of a transportation system may draft his/her operation plan to be applied to the transportation system with reference to an operation plan produced by the operation determination device 100.

The simulator 110 is configured to simulate an operation of carriage machinery. To simulate an operation of carriage machinery, the simulator 110 may simulate an operation over the entirety of a transportation system in addition to an operation of carriage machinery. To simulate an operation of a railway vehicle, for example, the simulator 110 needs to simulate operations of points, crossings, and signals; hence, the simulator 110 should simulate the operations.

In addition, the simulator 110 is configured to simulate dynamic/static states of carriage targets. In the case of a railway system as a transportation system, the simulator 110 should simulate entry/exit of passengers on a platform of a railway station, embarking/disembarking of passengers on railway vehicles, and transportation of passengers via railway vehicles.

The determination unit 120 is configured to determine an operation plan of carriage machinery using the simulator 110 to improve a stationary status of carriage targets on a platform. It is possible to determine an operation plan of carriage machinery when improving a stationary status of carriage targets on a platform since the determination unit 120 evaluates a stationary status of carriage targets on a platform in association with simulation of the simulator 110 configured to simulate an operation of carriage machinery. In this connection, the determination unit 120 may correspond to an example of a determination means.

The following description refers to an exemplary case of producing an operation plan of a carrier vehicle when the determination unit 120 improves a stationary status of carriage targets on a platform via reinforcement learning using rewards relating to a stationary status of carriage targets. When the operation determination device 100 handles carriage machinery as railway vehicles, it is possible for the determination unit 120 to use rewards which will be highly evaluated due to a smaller number of users, serving as carriage targets, who may stay on a platform of a railway station.

The determination unit 120 may use various types of rewards which can quantitatively evaluate a congestion of passengers.

For example, the determination unit 120 may calculate a stationary quantity of passengers as a total number of passengers staying on platforms in all the railway stations during stationary times of passengers on platforms of railway stations. Subsequently, the determination unit 120 may perform reinforcement using rewards which are highly evaluated due to a smaller stationary quantity of passengers.

Alternatively, the determination unit 120 may calculate a stationary quantity of passengers by totaling the number of passengers staying on a platform for each railway station with respect to all the railway stations. Subsequently, the determination unit 120 may perform reinforcement learning using rewards which will be highly evaluated due to a smaller stationary quantity of passengers.

The determination unit 120 is configured to learn setting values input to the module 130 via reinforcement learning. Herein, learning setting values input to the module 130 means learning which values to be set and input to the module 130 according to the status of a transportation system.

A larger number of action patterns in reinforcement learning may cause sparse opportunities to make an evaluation of individual patterns using rewards, which would be regarded as a factor in impeding the progress of learning. When the operation determination device 100 handles a single entire route of a railway system, it is necessary to consider a large number of operating targets such as railway points, crossings, and signals. When operations of operating targets are directly used as actions in reinforcement learning, it is necessary to consider an enormous number of action patterns, which would be regarded as a factor in impeding the progress of learning. In other words, this may cause an incapacity of performing reinforcement learning efficiently.

For this reason, the operation determination device 100 should automate an operation of an operating target using the module 130 to some extent. This may reduce the number of action patterns in reinforcement learning, thus facilitating learning with ease.

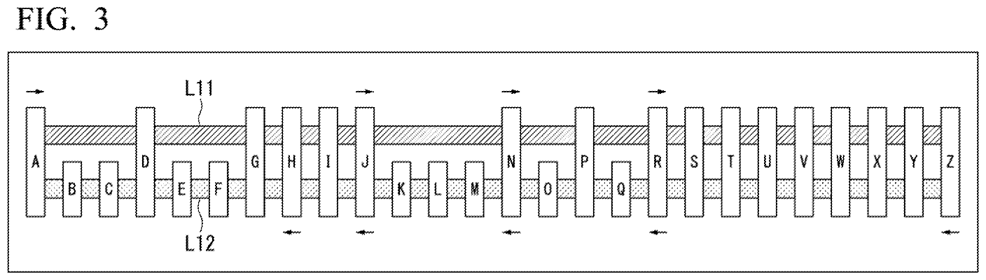

As described later with reference to FIGS. 3-6, the module 130 is configured to set a plurality of parameter values, representing operations executable in part of a transportation system, based on a plurality of input values the number of which is smaller than the number of parameters. Herein, parameters are input parameters for simulation models. The module 130 or the determination unit 120 inputs to the simulator 110 a plurality of parameter values representing an operation subjected to simulation.

In the case of a transportation system as a railway system, it is possible to provide the module 130 for each station and to automate a certain operation for each station to some extent. The determination unit 120 may instruct the module 130 to determine whether or not a railway vehicle may loop back at a station allowing for loopback of a railway vehicle. In this case, the module 130 sets parameter values which can be set at the station based on an instruction as to whether or not to loop back a railway vehicle and a status of the railway vehicle to enter into the station. For example, the module 130 sets parameter values representing operations of points and signals at the station.

The module 130 may set parameter values in a rule-based manner. For example, an engineer may manually set prescribed rules as a rule basis with respect to the operation determination device 100. The module 130 selects a rule according to the status of a railway system subjected to simulation, thus setting parameter values representing an operation induced by the selected rule.

When the module 130 sets operations with respect to facilities of a station, it is possible to use the status of a railway station when selecting rules, e.g., the status of operating targets such as points and signals at the station and the status of a railway vehicle entering into the station such as the position and the speed of a railway vehicle.

Alternatively, the module 130 may learn how to set parameters via reinforcement learning. In this case, it is possible to assume that the module 130 may perform reinforcement learning using rewards differently than rewards used in the determination unit 120. For example, it is possible to use rewards which will be highly evaluated upon obtaining results as instructed by input values from the determination unit 120 in the case of a straight or loopback travel of a railway vehicle.

The aforementioned reinforcement learning may achieve efficient processing by simulating part of a transportation system, e.g., by simulating a railway vehicle and part of a station to be operated by the module 130 in a railway station.

Alternatively, the module 130 may learn how to set parameter values via machine learning other than reinforcement learning. For example, the module 130 may learn how to set parameter values according to genetic algorithms.

The module 130 may set parameter values responsive to input values from the determination unit 120 based on constraints used for an operation of a transportation system. For example, the module 130 may set parameter values according to railway-operation rules and other operation restrictions due to rules of security facilities. For example, the module 130 may further set parameter values representing operations of railway points according to constraints in which branching directions of points should be limited according to the status of signals.

According to an instruction as to whether or not to loop back a railway vehicle at a station and a status of the railway vehicle entering into the station, the module 130 may determine settings of points and signals via simulation based on constraints relating to settings of signals at the station and other constraints relating to settings of points at the station.

As an example of constraints relating to settings of signals, it is possible to mention restriction conditions in which a local signal will be turned to a blue signal after a railway vehicle enters into a closed section just before a station yard.

As an example of constraints relating to settings of points, it is possible to mention constraints in which a railway vehicle in an attempt to run straightly may enter a first platform while a railway vehicle in an attempt to loop back at a station may enter a second platform.

In the above, the processing of the determination unit 120 has been described by way of an example to realize the operation of the determination unit 120 via reinforcement learning; however, the operation determination device 100 can be realized via mixed integer programming. For example, the operation determination device 100 may process a problem of an objective function to minimize a quantitative evaluation status of stationary carriage targets under constraints relating to crews who may operate railway vehicles, the number of railway vehicles, and the number of stations according to mixed integer programming or the like, thus calculating parameter values and creating an operation plan based on the calculated parameter values. That is, a methodology of realizing the determination unit 120 is not necessarily limited to the aforementioned examples.

FIG. 2 is a schematic diagram showing an example of data flows in the simulator 110. In the configuration shown in FIG. 2, the simulator 110 includes an operation simulator 111, a people-flow simulator 112, and an entry/exit simulator 113.

The operation simulator 111 is configured to simulate an operation of carriage machinery. For this reason, the operation simulator 111 is configured to simulate the entirety of a transportation system in addition to carriage machinery.

Before starting simulation, the operation simulator 111 should acquire a route setting of a transportation system and a start condition (or an initial condition) such as the position of carriage machinery when starting simulation. Subsequently, the operation simulator 111 executes simulation upon receiving an operation input to a transportation system by setting parameter values for a simulation model.

In addition, the operation simulator 111 is configured to simulate embarking/disembarking events of carriage targets on carriage machinery. In the case of a railway system as a transportation system subjected to simulation and people (or users) as carriage targets, the operation simulator 111 inputs the number of passengers on a platform of a station so as to output the number of disembarking passengers.

For example, the number of embarking passengers and the number of disembarking passengers may be calculated according to predetermined expressions of calculations or predetermined calculation rules.

For example, a manager of the operation determination device 100 may manually set calculation expressions or calculation rules in advance according to statistics about the number of embarking/disembarking passengers for each time zone and for each day of the week at actual stations.

Alternatively, the simulator 110 may calculate the number of embarking passengers without exceeding a capacity of passengers who can ride on railway vehicles upon assuming that some users will embark on railway vehicles each time of arriving at a platform within the number of users staying at a platform. In addition, the simulator 110 may calculate the number of disembarking passengers upon assuming that some users will disembark from railway vehicles each time of arriving at a platform within in the number of users who ride on railway vehicles.

Any one of the simulator 110, the operation simulator 111, and the people-flow simulator 112 may calculate the number of embarking passengers and the number of disembarking passengers.

As results of simulation, for example, the operation simulator 111 may output the position of carriage machinery and the number of passengers riding on each carrier vehicle in each sampling time.

The operation simulator 111 may receive an operation-failure scenario causing a failure in part of a transportation system. For example, it is possible to rapidly take countermeasures against an actual occurrence of failures since the operation determination device 100 has created in advance a contingency operation plan against failures, e.g., an interruption occurring between two adjacent stations, unavailability of stations, or the like.

The people-flow simulator 112 is configured to simulate dynamic/static states of carriage targets on a platform such as dynamic/static states of users on a station platform. For example, the people-flow simulator 112 may update the number of stationary people staying on a station platform by adding the number of people entering onto a station platform and the number of passengers getting off railway vehicles while subtracting the number of passengers getting on railway vehicles and the number of people exiting from a station platform. For example, the people-flow simulator 112 is configured to calculate and output the number of stationary people for each station platform and in each sampling time.

The entry/exit simulator 113 is configured to calculate an entry count of carriage targets onto a platform and an exit count of carriage targets from a platform. In the case of a railway system as a transportation system subjected to simulation and people (users) as carriage targets, the entry/exit simulator 113 is configured to calculate the number of people entering onto a station platform and the number of people exiting from a station platform.

For example, the entry count and the exit count are calculated according to calculation expressions or calculation rules which are determined in advance.

For example, a manager of the operation determination device 100 may manually set in advance calculation expressions or calculation rules for the entry count and the exit count based on statistics relating to embarking/disembarking passengers for each day of the week in each time zone at actual stations.

Alternatively, the entry/exit simulator 113 may produce a certain entry count in a certain time within a range not causing an entry restriction on a platform.

As to the exit count, it is possible to calculate the number of residual users by subtracting the number of transit users who may stay on a platform from the number of disembarking passengers from railway vehicles.

As to the number of transit users who may stay on a platform, for example, a manager of the operation determination device 100 may manually prepare calculation expressions or calculation rules based on statistic data at actual stations.

Alternatively, the entry/exit simulator 113 may calculate the number of stationary users who may stay on a platform by rounding off a certain ratio as an integer within the number of disembarking users from railway vehicles.

In this connection, a “clock instruction” is an instruction to adjust a simulation timing to a designated timing.

FIG. 3 is a schematic diagram showing an example of routes in a transportation system for which the operation determination device 100 may produce an operation plan of carriage machinery.

FIG. 3 shows an example of railway routes. FIG. 3 exemplarily shows various stations located between station A to station Z. In addition, line L11 shows stopping stations for a rapid-transit train. Line L12 shows stopping stations for a local train (which may stop at each station).

Arrows show loopback-permitted stations for trains or loopback-permitted directions. Upper arrows above stations indicate permission for a train which travels from station Z to station A, to loop back to station Z. Lower arrows below stations indicate permission for a train which travels from station A to station Z, to loop back to station A.

In this example, stations J, N, R indicate both permission for a train coming from station A to loop back to station A and permission for a train coming from station Z to loop back to station Z. Stations H, Z indicate permission for a train coming from station A to loop back to station A. Station A indicates permission for a train coming from station Z to loop back to station Z.

In this connection, all trains are permitted to loop back to original stations at stations A and Z positioned at opposite ends of routes.

When simulating a route having a certain scale as a railway system as shown in FIG. 3, it is necessary to increase the number of operations which can be implemented in the railway system. In this case, it is substantially impossible to achieve reinforcement learning as described above if operations of a railway system are directly subjected to reinforcement learning by the determination unit 120.

For example, an actual route or another route having the same scale of the route shown in FIG. 3 may include eighty-eight points, indicating that the number of operation patterns applied to points would be the 88th power of 2 combinations. This may raise an incapacity of efficiently performing reinforcement learning if numerous operations applied to points are subjected to reinforcement learning by the determination unit 120.

In contrast, the determination unit 120 needs to instruct the module 130 a decision as to whether a train should travel straight or loop back to its original station if the module 130 could automate an operation of a train to travel straight and an operation of a train to loop back to its original station. Trains should loop back to original stations at stations A and Z, and therefore the determination unit 120 needs to instruct the module 130 a loopback approval/disapproval at stations H, J, N, R. Station H allows for a loopback in a single direction while stations J, N, R allow for loopbacks in opposite directions; hence, the determination unit 120 should produce seven instructions, i.e., 1+2×3=7, with respect to the module 130. Therefore, the number of instruction patterns which the determination unit 120 applies to the module 130 would be the seventh power of 2 combinations.

As described above, the module 130 is configured to automate operations in simulation to some extent, it is possible to relatively reduce the number of action patterns in reinforcement learning by the determination unit 120, thus securing a capacity of efficiently performing reinforcement learning.

Since the simulator 110 employs a simulation model to simulate individual operation, it is possible to make a setting of detailed failures such as an inoperability of a specific point.

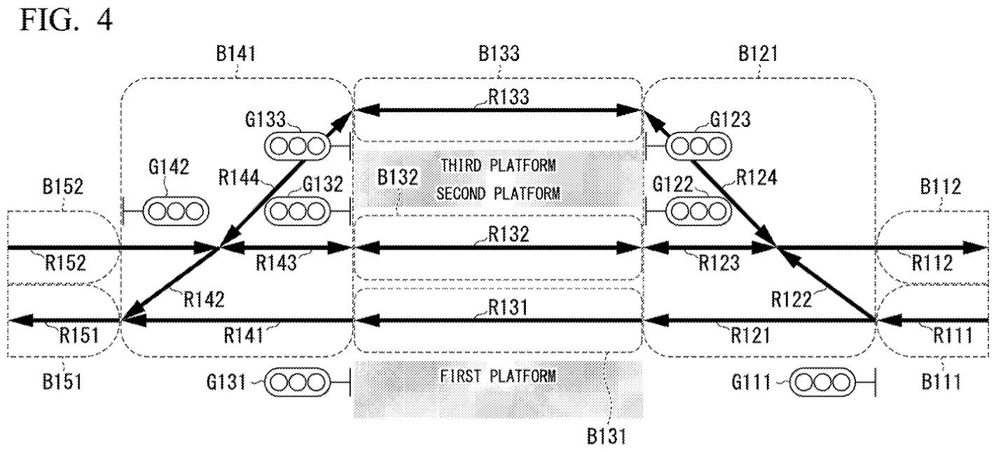

FIG. 4 is a schematic diagram showing a configuration example of facilities in a station relating to a simulation model of the simulator 110.

The station shown in FIG. 4 includes a first platform, a second platform, and a third platform. Railways R131, R132, R133 correspond to the first platform, the second platform, and the third platform. When railway vehicles stop at the railways, users may embark on railway vehicles at their platform(s) or users may disembark from railway vehicles at their platform(s).

Railway vehicles entering into the station through a railway R111 may reach the railway R131 corresponding to the first platform through a railway R121. In addition, railway vehicles entering into the station through the railway R111 may reach the railway R132 corresponding to the second platform through railways R122 and R123. Moreover, railway vehicles entering into the station through the railway R111 may reach the railway R133 corresponding to the third platform through a railway R124.

Railway vehicles entering into the station through a railway R152 may reach the railway R132 corresponding to the second platform through a railway R143. In addition, railway vehicles entering into the station through the railway R152 may reach the railway R133 through a railway R144.

The railway R132 may depart for a railway R151. Railway vehicles positioned at the railway R131 may reach the railway R151 through a railway R141.

Each of the railways R132 and R133 may depart for any one of a railway R112 and the railway R151.

Railway vehicles positioned at the railway R132 may reach the railway R112 through the railway R121. In addition, railway vehicles positioned at the railway R132 may reach the railway R151 through the railway R143 and a railway R142.

Railway vehicles positioned at the railway R133 may reach the railway R112 through the railway R124. In addition, railway vehicles positioned at the railway R133 may reach the railway R151 through the railway R144 and the railway R142.

A signal G111 serves as a local signal indicating an approval/disapproval of entrance for railway vehicles entering into the station through the railway R111. A signal G142 serves as a local signal indicating an approval/disapproval of entrance for railway vehicles entering into the station through the railway R152.

A signal G131 serves as a departure signal indicating an approval/disapproval of departure for railway vehicles positioned at the railway R131 to depart for the railway R151.

A signal G122 serves as a departure signal indicating an approval/disapproval of departure for railway vehicles positioned at the railway R132 to depart for the railway R112. A signal G132 serves as a departure signal indicating an approval/disapproval of departure for railway vehicles positioned at the railway R132 to depart for the railway R151.

A signal G123 serves as a departure signal indicating an approval/disapproval of departure for railway vehicles positioned at the railway R133 to depart for the railway R112. A signal G133 serves as a departure signal indicating an approval/disapproval of departure for railway vehicles positioned at the railway R133 to depart for the railway R151.

Reference signs B111, B112, B121, B131, B132, B133, B141, B151, B152 denote closed sections.

The module 130 controls courses of railway vehicles by switching over points and performs move/stop controls over railway vehicles by switching over indications of signals.

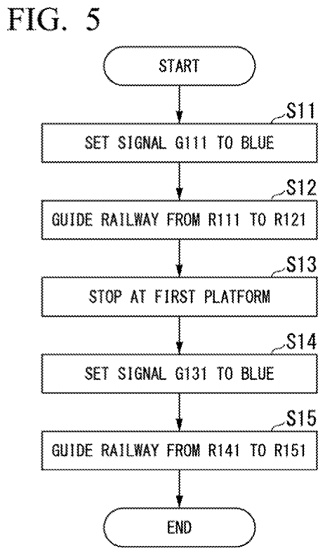

FIG. 5 is a flowchart showing an exemplary procedure performed by the module 130 for straight movement of railway vehicles. FIG. 5 shows an exemplary procedure adapted to the example of FIG. 4 in which the module 130 temporarily stops railway vehicles entering into the station through the railway R111 at the railway R131 and then straightly moves railway vehicles toward the railway R151.

According to the procedure of FIG. 5, when railway vehicles reach the railway R111 (or the closed section B111), the module 130 sets the signal G111 to a blue signal (step S11). This allows railway vehicles to enter into the closed section B121.

The module 130 operates the direction of points in advance so as to guide railway vehicles in a direction from the railway R111 to the railway R121 (step S12).

The module 130 maintains the signal G131 at a red signal so as to stop railway vehicles at the railway R131 (step S13). Since railway vehicles are stopped at the first platform, it is possible to simulate movements of users who may embark on or disembark from railway vehicles on the first platform.

Upon establishing a departure condition of railway vehicles, for example, in which twenty seconds have elapsed after railway vehicles stopped at the platform, the module 130 sets the signal G131 to a blue signal (step S14). This allows railway vehicles to enter into the closed section B141.

In addition, the module 130 guides railway vehicles in a direction from the railway R141 to the railway R151 (step S15). Specifically, the module 130 needs to operate the direction of points in advance so as not to cause any problems when railway vehicles move from the railway R141 to the railway R151.

After step S15, the module 130 exits the procedure of FIG. 5. Accordingly, railway vehicles may further move outside the station through the railway R151.

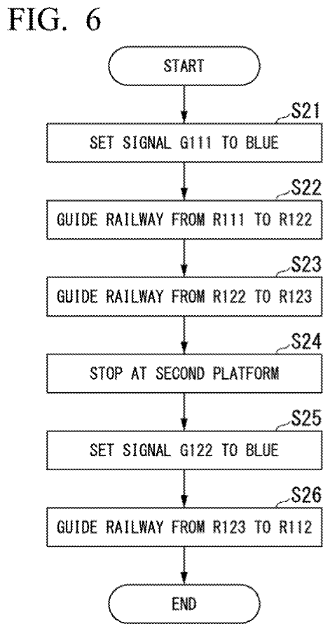

FIG. 6 is a flowchart showing an exemplary procedure performed by the module 130 for loopback movement of railway vehicles. FIG. 6 shows an exemplary procedure adapted to the example of FIG. 4 in which the module 130 temporarily stops railway vehicles entering into the station through the railway R111 at the railway R132 and then loops back railway vehicles towards the railway R111.

In FIG. 6, step S21 is identical to step S11 of FIG. 5.

After step S21, the module 130 operates the direction of points in advance to guide railway vehicles in a direction from the railway R111 to the railway R122 (step S22) and to further guide railway vehicles in a direction from the railway R122 to the railway R123 (step S23).

The module 130 maintains the signals G122 and G132 at red signals so as to guide railway vehicles in a direction from the railway R122 to the railway R132, thereafter, the module 13 stops railway vehicles at the railway R132 (step S24). Since railway vehicles are stopped at the second platform, it is possible to simulate movements of users who may embark on or disembark from railway vehicles on the second platform.

Upon establishing a departure condition of railway vehicles, for example, in which twenty seconds have elapsed after railway vehicles stop at the platform, the module 130 sets the signal G122 to a blue signal (step S25). This allows railway vehicles to enter into the closed section B121.

In addition, the module 130 operates the direction of points in advance to guide railway vehicles in a direction from the railway R123 to the railway R112 (step S26).

After step S26, the module 130 exits the procedure of FIG. 6. Accordingly, railway vehicles may move outside the station through the railway R112.

Since the module 130 autonomously performs a straight-movement process of railway vehicles and a loopback-movement process of railway vehicles, as described above, the determination unit 120 may instruct the module 130 to move railway vehicles straightly or to loop back railway vehicles to original positions. This procedure needs a relatively small number of action patterns to be performed by the determination unit 120 such that the determination unit 120 can accomplish reinforcement learning.

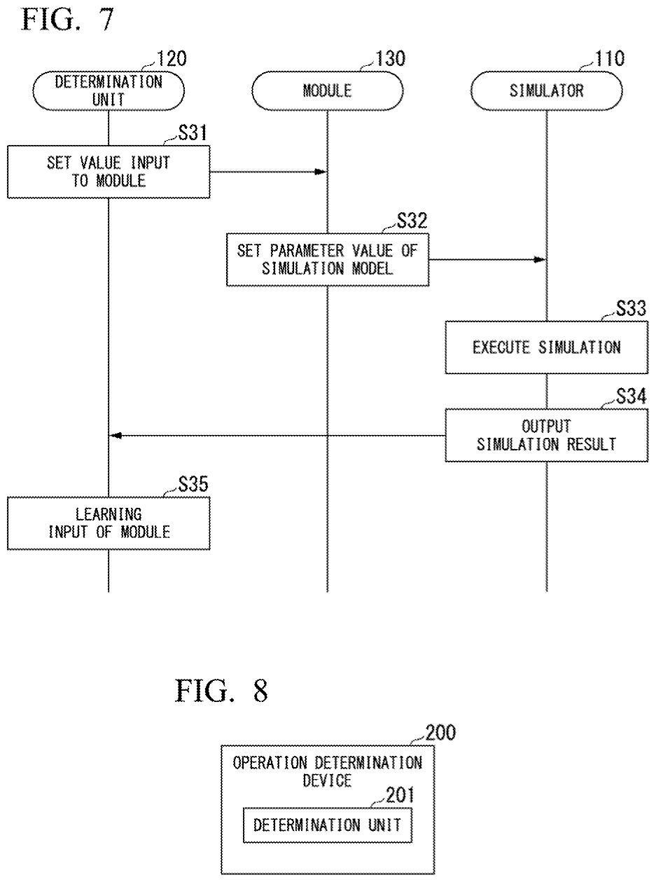

FIG. 7 is a flowchart showing an exemplary procedure performed by the operation determination device 100. FIG. 7 shows an exemplary procedure performed by the operation determination device 100 in which the determination unit 120 learns values input to the module 130. When performing reinforcement learning with the determination unit 120, for example, the operation determination device 100 should repeatedly perform the procedure of FIG. 7 in each sampling time of simulation.

According to the procedure of FIG. 7, the determination unit 120 sets values input to the module 130 (step S31). Based on the set values, the module 130 sets parameter values indicating an operation of a transportation model (step S32).

The simulator 10 executes a simulation of a transportation model using parameter values set by the module 130 (step S33). Subsequently, the simulator 110 outputs simulation results (step S34). In particular, the simulator 110 transmits to the determination unit 120 the number of stationary people on each platform at each station as the information for the determination unit 120 to calculate rewards.

The determination unit 120 learns values input to the module 130 (step S35). Specifically, the determination unit 120 calculates rewards based on simulation results. Subsequently, the determination unit 120 may update rules of setting input values to the module 130 during learning based on the values set in step S31 and the evaluation indicated by rewards.

After step S35, the operation determination device 100 exits the procedure of FIG. 7.

As to a transportation system including carriage machinery for carrying carriage targets and platforms for keeping carriage targets to be loaded to carriage machinery, as described above, the determination unit 120 may produce an operation plan of carriage machinery using a simulator configured to simulate an operation of carriage machinery when improving a stationary status of carriage targets on platforms.

Accordingly, it is possible to produce an operation plan considering users' convenience since the determination unit 120 is configured to produce an operation plan to improve a stationary status of carriage targets.

The determination unit 120 is configured to produce an operation plan via reinforcement learning using rewards relating to a stationary status of carriage targets. The determination unit 120 searches for an operation plan based on rewards when improving a stationary status of carriage targets, thus outputting the operation plan for improving the stational status of carriage targets.

Thus, the determination unit 120 is able to generate an operation plan to reduce the number of stationary carriage targets as small as possible. In this sense, it is possible for the operation determination device 100 to produce an operation plan considering users' convenience.

The module 130 is configured to set parameter values, representing operations which can be implemented by part of a transportation system, based on a plurality of input values, the number of which is smaller than the number of parameters. The determination unit 120 is configured to learn values input to the module 130 via reinforcement learning.

Accordingly, it is possible for the determination unit 120 to perform reinforcement learning irrespective of a large number of operations which can be implemented by a transportation system.

The module 130 is configured to set parameter values responsive to input values thereof according to constraints used for an operation of a transportation system.

Thus, the module 130 is able to perform simulation using constraints for an operation of a transportation system with high accuracy. In addition, it is possible to automate the processing of the module 130 due to a reduction in a freedom degree in the processing of the module 130.

The determination unit 120 uses rewards which will be highly evaluated due to a smaller number of carriage targets which may stay on a station platform.

As a result, the determination unit 120 may learn how to set values input to the module 130 such that the number of carriage targets staying on a station platform will be reduced as small as possible. In this sense, the operation determination device 100 is able to produce an operation plan considering users' convenience.

In addition, the module 130 is configured to set parameter values which can be set to a station according to an input thereof instructing as to whether or not to loop back railway vehicles at the station and a status of railway vehicles entering into the station.

Accordingly, the determination unit 120 needs to instruct the module 130 as to whether or not to loop back railway vehicles at the station since the determination unit 120 needs to set a relatively small number of patterns. Thus, it is possible to perform reinforcement learning irrespective of a large number of operations which can be implemented by a transportation system.

The module 130 is configured to set signals and points in simulation according to an input instructing as to whether or not to loop back railway vehicles at a station and a status of railway vehicles entering into the station based on constraints relating to settings of signals at the station and constraints relating to settings of points at the station.

Accordingly, it is possible for the module 130 to perform simulation reflecting constraints relating to settings of signals and constraints relating to settings of points with high accuracy.

In addition, the operation determination device 100 is configured to perform the following processes with respect to a system including carriage machinery (e.g., railway vehicles) for carrying carriage targets (e.g., passengers) and facilities relating to an operation of carriage machinery.

The operation determination device 100 inputs an operation of carriage machinery (see step S32 in FIG. 7) so as to simulate the system according to the input operation (step S33). In simulation as described above with reference to FIG. 2, the operation determination device 100 should produce the number of carriage targets getting on carriage machinery on a platform and the number of carriage targets getting off carriage machinery on the platform. Subsequently, the operation determination device 100 produces a stationary status of carriage targets on the platform based on the number of entries on the platform and the number of exits from the platform as well as the number of embarking carriage targets and the number of disembarking carriage targets. The above process can be regarded as a process which allows the operation determination device 100 to produce a quantitative evaluation status of carriage targets.

In addition, the operation determination device 100 produces an operation of carriage machinery to improve the stationary status of carriage targets (see step S35 in FIG. 7). This process can be regarded as a process which allows the operation determination device 100 to produce an operation of carriage machinery in order to improve a quantitative evaluation status of carriage targets.

To summarize the above, it is possible to paraphrase the processing of the operation determination device 100 as follows.

The operation determination device 100 produces the number of embarking/disembarking carriage targets with carriage machinery to be operated according to a prescribed operation in a system including carriage machinery for carrying carriage targets and facilities relating to the operation of carriage targets. The operation determination device 100 produces a stationary status of carriage targets on a platform based on the number of entries on the platform and the number of exits from the platform as well as the number of embarking/disembarking carriage targets. In other words, the operation determination device 100 produces a quantitative evaluation status of carriage targets. Subsequently, the operation determination device 100 produces an operation of carriage machinery to improve a stationary status of carriage targets. In other words, the operation determination device 100 produces an operation of carriage machinery to improve a quantitative evaluation status of carriage targets.

In this connection, the operation determination device 100 may perform a process to produce a quantitative evaluation status of carriage targets according to the operation of carriage machinery.

FIG. 8 is a block diagram showing a configuration example of an operation determination device according to the exemplary embodiment.

In the configuration shown in FIG. 8, an operation determination device 200 includes a determination unit 201.

The determination unit 201 corresponds to an example of a determination means.

In this configuration, the determination unit 201 is configured to produce an operation plan of carriage machinery when improving a stationary status of carriage targets on a platform by use of a simulator configured to simulate an operation of carriage machinery with respect to a transportation system including carrier machinery for carrying carriage targets and a platform for carriage targets with carriage machinery.

As described above, it is possible to produce an operation plan considering users' convenience since the determination unit 201 produces an operation plan to improve a stationary status of carriage targets.

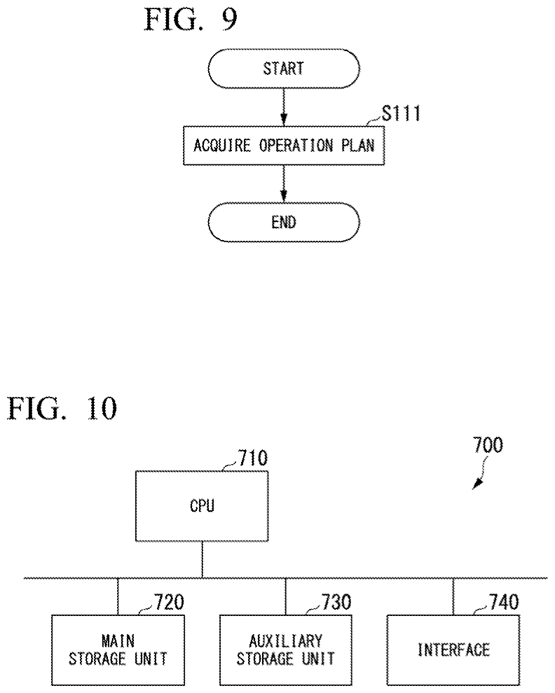

FIG. 9 is a flowchart showing an example of a procedure in an operation determination method according to the exemplary embodiment.

The procedure shown in FIG. 9 includes an operation plan acquisition process (step S111).

The operation plan acquisition process is configured to produce an operation plan of carriage machinery when improving a stationary status of carriage targets on a platform by use of a simulator configured to simulate an operation of carriage machinery with respect to a transportation system including carrier machinery for carrying carriage targets and a platform for carriage targets with carriage machinery.

The operation plan acquisition method is able to produce an operation plan considering users' convenience such that an operation plan is produced to improve a stationary status of carriage targets.

FIG. 10 is a block diagram showing the configuration of a computer according to any one of the exemplary embodiments.

In the configuration shown in FIG. 10, a computer 700 includes a CPU 710, a main storage unit 720, an auxiliary storage unit 730, and an interface 740.

At least any one of the operation determination device 100 and the operation determination device 200 can be implemented by the computer 700. In this case, operations relating to the aforementioned processing parts are stored on the auxiliary storage unit 730 in the form of programs. The CPU 710 reads programs from the auxiliary storage unit 730, unwinds programs on the main storage unit 720, and executes the aforementioned processes according to programs. In addition, the CPU 710 secures a storage area corresponding to each storage unit according to programs on the main storage unit 720. The interface 740 having a communication function may conduct communications between each unit and other devices under the control of the CPU 710.

To implement the operation determination device 100 with the computer 700, operations relating to various parts such as the simulator 110, the determination unit 120, and the module 130 are stored on the auxiliary storage unit 730 in the form of programs. The CPU 710 reads programs from the auxiliary storage unit 730, unwinds programs on the main storage unit 720, and executes the aforementioned processes according to programs.

In addition, the CPU 710 secures storage areas necessary for the processes of the operation determination device 100 on the main storage unit 720 according to programs. The interface 740 having a communication function may perform an input/output operation of the operation determination device 100 such as an input of a simulation model and an output of an operation plan by conducting communications under the control of the CPU 710.

To implement the operation determination device 100 with the computer 700, the operation of the determination unit 120 is stored on the auxiliary storage unit 730 in the form of programs. The CPU 710 reads programs from the auxiliary storage unit 730, unwinds programs on the main storage unit 720, and executes the aforementioned processes according to programs.

In addition, the CPU 710 may secure storage areas needed for the process of the operation determination device 100 on the main storage unit 720 according to programs. The interface 740 having a communication function performs an input/output operation of the operation determination device 100 such as an input of a simulation model and an output of an operation plan by conducting communications under the control of the CPU 710.

In this connection, programs realizing part of or the entirety of the operation determination device 100 and the operation determination device 200 can be stored on computer-readable storage media, wherein a computer system may load and execute programs stored on storage media, thus achieving the aforementioned processes. Herein, the term “computer system” may include an OS (Operating System) and hardware such as peripheral devices.

The term “computer-readable storage media” refers to flexible disks, magneto-optical disks, ROM (Read-Only Memory), portable media such as CD-ROM (Compact-Disk Read-Only Memory), and storage devices such as hard disks embedded in computer systems. The aforementioned programs may achieve some of the foregoing functions, or the aforementioned programs can be combined with pre-installed programs of computer systems so as to achieve the foregoing functions.

Heretofore, the present invention has been described by way of exemplary embodiments with reference to the accompanying drawings, wherein concrete configurations are not necessarily limited to the foregoing embodiments; hence, the present invention may include any design choices without departing from the subject matter of the invention.

### INDUSTRIAL APPLICABILITY

The foregoing exemplary embodiments of the present invention are applicable to operation determination devices, operation determination methods, and storage media.

### REFERENCE SIGNS LIST

100, 200 operation determination device
110 simulator
111 operation simulator
112 people-flow simulator
113 entry/exit
120, 201 determination unit
130 module

What is claimed is:

1. An operation determination device adapted to a system including a carriage machinery for carrying carriage targets and facilities relating to an operation of the carriage machinery, comprising a determination means configured to produce an operation plan of the carriage machinery to improve a quantitative evaluation status of the carriage targets using a simulator configured to simulate the operation of the carriage machinery.

2. The operation determination device according to claim 1, further comprising the simulator, wherein the determination means is configured to produce the operation plan of the carriage machinery in order to improve the stationary status of the carriage targets on a platform of the carriage targets by the carriage machinery via reinforcement learning using rewards relating to the stationary status of the carriage targets.

3. The operation determination device according to claim 2, further comprising a module configured to set parameter values representing operations to be implemented by part of the system based on a plurality of input values whose number is smaller than a number of the parameter values, wherein the determination means is configured to learn setting values input to the module via the reinforcement learning.

4. The operation determination device according to claim 3, wherein the module is configured to set the parameter values responsive to the input values thereof according to a restrictive condition used for an operation of the system.

5. The operation determination device according to claim 3, wherein the system is a railway system, and wherein the determination means uses the rewards to be highly evaluated due to a smaller number of the carriage targets staying on a platform of a station.

6. The operation determination device according to claim 5, wherein the module is configured to set the parameter values to the station based on an input instructing whether or not to loop back a railway vehicle at the station and a status of the railway vehicle entering into the station.

7. The operation determination device according to claim 6, wherein the module is configured to set a signal and a point in simulation based on the input instructing whether or not to loop back the railway vehicle at the station and the status of the railway vehicle entering into the station as well as a restrictive condition relating to a setting of the signal at the station and a restrictive condition relating to a setting of the point at the station.

8. An operation determination method adapted to a system including a carriage machinery for carrying carriage targets and facilities relating to an operation of the carriage machinery, comprising a step of producing an operation plan of the carriage machinery to improve a quantitative evaluation status of the carriage targets using a simulator configured to simulate the operation of the carriage machinery.

9. A non-transitory computer-readable storage medium configured to store a program causing a computer adapted to a system including a carriage machinery for carrying carriage targets and facilities relating to an operation of the carriage machinery to implement a step of producing an operation plan of the carriage machinery to improve a quantitative evaluation status of the carriage targets using a simulator configured to simulate the operation of the carriage machinery.
